(19) United States
(12) Patent Application Publication
(10) Pub. No.: US 2008/0239975 A1
(43) Pub. Date: Oct. 2, 2008

(54) Message collision handling

(75) Inventors: Alan K. Hunt, Dallas, TX (US); Ramin Borazjani, Plano, TX (US)

Correspondence Address: DOCKET CLERK, P.O. DRAWER 800889, DALLAS, TX, 75380, US

(73) Assignee: Crane Co., Stamford, CT (US)

(21) Appl. No.: 11/728,752

(22) Filed: Mar. 27, 2007

(51) Int. Cl. H04J 1/16

(52) U.S. Cl. 370/252; 370/401

(57) ABSTRACT

A collision handling receiver for use in a data communication network. The collision handling system and method comprises collision handling receivers together with transmitters inserting pseudo-random delays. Accordingly, multiple sources may transmit simultaneous messages to a receiver so that the messages arrive with varying signal levels and times of arrival. The receiver sorts the symbols into separate sequences by grouping together symbols having similar time of arrival. In addition, the receiver retains the sequences with sufficiently reliable symbol detection, for example, when 75% of the symbols in a sequence are detected with sufficient quality. Receiver then ranks the retained transmitters by received signal level and decodes the messages from transmitters with highest received signal level.

### TECHNICAL FIELD

This disclosure is generally directed to data communication systems and more particularly to systems and methods for handling message collisions.

### BACKGROUND

Conventional data communication systems typically use a shared medium such as, for example, a wireless network. A receiver may receive messages from two or more transmitters simultaneously. Such occurrences are generally referred to as “collisions”. Although conventional systems typically can detect whether a collision has occurred, such systems are not able to decode colliding messages. In addition, conventional systems fail to enumerate multiple messages.

There is therefore a need for a system and method to handle message collisions in a data communication system. In particular, there is a need for improved receivers and transmitters to accommodate handling message collisions.

### SUMMARY

This disclosure provides a system and method for handling message collisions in a data communication system. This disclosure also provides a system and method for handling message collisions in a receiver and in a transmitter.

According to one embodiment of the present disclosure, a receiver sorts the symbols into separate sequences by grouping together symbols having similar time of arrival. In other words, each periodic sequence of symbols represents the signal from a distinct transmitter. In addition, receiver retains the sequences with sufficiently reliable symbol detection, for example, when 75% of the symbols in a sequence are detected with sufficient quality. Receiver 102 then ranks the received messages by received signal level and decodes the messages from transmitters 101 with highest received signal level.

In still another embodiment, the present disclosure provides a collision handling receiver for use in a data communication network. The receiver includes a matched filter to detect symbols from an input signal. The receiver also includes a mechanism to sort the symbols into separate sequences based on their respective times of arrival and a decoders to decode the sorted symbol sequences.

In yet another embodiment, the present disclosure provides a method of handling collisions in a receiver for use in a data communication network. The method includes receiving input signals originally transmitted with independent pseudo-random delays and detecting qualified symbol sequences from the input signals. The method also includes a mechanism to sort the symbols into separate sequences based on their respective times of arrival. The method further includes retaining the sequences with sufficient signal quality and ranking the retained sequences by received signal strength. The method still further includes decoding the input signals with the highest received signal strength.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a somewhat simplified illustration of a data communication system according to one embodiment of the present disclosure;

FIG. 2 is a somewhat simplified flow diagram illustrating an exemplary method for handling collisions in a receiver according to one embodiment of the present disclosure; and

FIG. 3 illustrates exemplary matched filter output and symbol detections in a receiver according to one embodiment of the present disclosure.

### DETAILED DESCRIPTION

The present disclosure provides a system and method of handling message collisions in a data communication system.

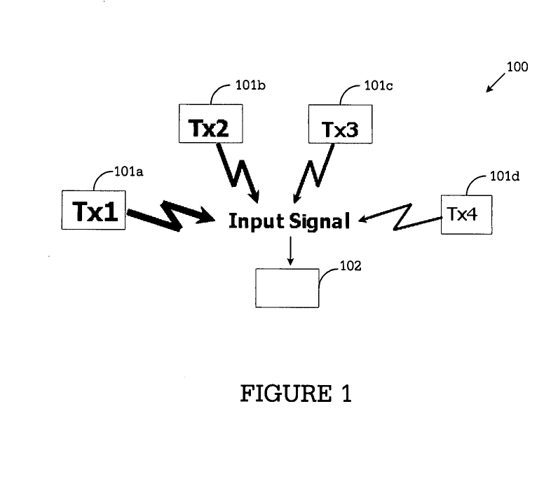

FIG. 1 is a somewhat simplified illustration of wireless data communication system 100 according to one embodiment of the present disclosure. Each transmitter 101a, 101b, 101c and 101d (sometimes collectively referred to herein as transmitter 101) transmits a message containing a pseudo-random delay ranging from zero to one symbol period to receiver 102.

Although only four transmitters 101 are shown in FIG. 1, it should be understood that any suitable number of transmitters may be included in wireless data communication system 100. Similarly, it should be understood that although only one receiver 102 is shown in FIG. 1, any suitable number of receivers may be included in wireless data communication system 100. In one embodiment, the present disclosure provides a collision handling receiver, such as receiver 102. Receiver 102 may be used in any suitable data communication network including, for example, in a direct sequence spread spectrum communication network.

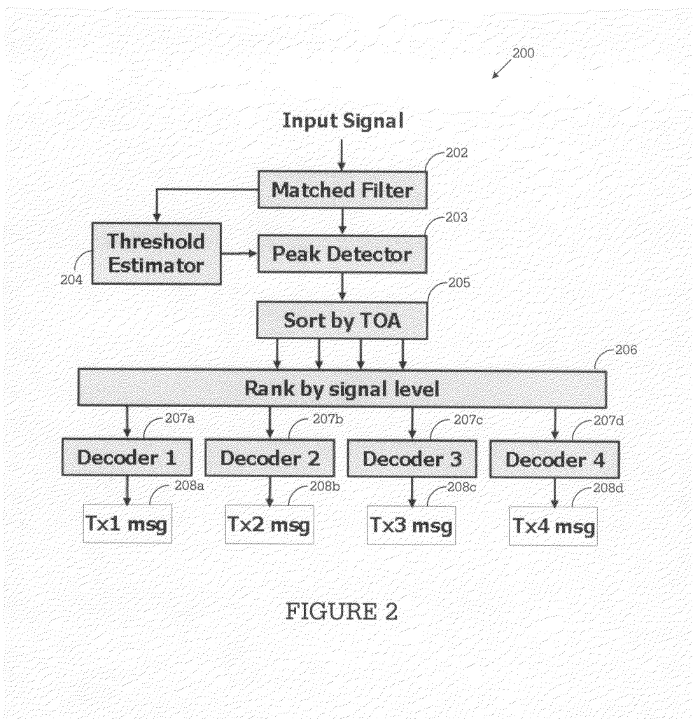

Receiver 102 detects symbols using a matched filter, as later described herein in conjunction with FIG. 2. Multiple sources may transmit simultaneous messages to receiver 102. Each message preferably includes a pseudo-random delay provided by the transmitter according to one embodiment of the present disclosure. When the input signals arrive at receiver 102, the input signals typically vary within a small range of signal levels.

At receiver 102, the input signal is passed through a matched filter. The matched filter output is analyzed to produce an adaptive detection threshold. Local energy peaks above the detection threshold are sorted by their respective time of arrivals. The sorted symbol sequences are then ranked by signal level and assigned to separate decoders for decoding.

FIG. 2 is a somewhat simplified flow diagram illustrating an exemplary method 200 for handling collisions in a receiver, such as receiver 102 shown in FIG. 1, according to one embodiment of the present disclosure. The pseudo-random delay described earlier creates time diversity and thus permits colliding messages to be distinguished at receiver 102 by the respective time of arrivals of each message (and respective signal strengths).

In one embodiment, receiver 102 receives the input signal in step 201 and passes each signal through a matched filter in step 202. In step 203 receiver 102 detects each qualified symbol as it arrives and notes the signal strength and time of arrival of each symbol, i.e., modulo T, where T is one symbol period, using the peak detector in step 204. It should be understood that qualified symbols are typically those with sufficient received signal strength and relatively high signal to noise ratios, although any suitable symbol may be used in accordance with the present disclosure.

In one embodiment, local energy peaks above detection threshold are sorted by their respective time of arrivals in step 204. Receiver 102 sorts the symbols into separate sequences by grouping together symbols having similar time of arrival in step 205. In other words, each periodic sequence of symbols preferably represents the signal from a distinct transmitter 101.

In addition, receiver 102 retains the sequences with sufficiently reliable symbol detection, for example, when 75% of the symbols in a sequence are detected with sufficient quality. In step 206, receiver 102 then ranks the retained sequences from transmitter 101 by their respective received signal strengths or levels. Receiver 102 also decodes the messages from transmitters 101 with highest received signal level according to one embodiment of the present disclosure.

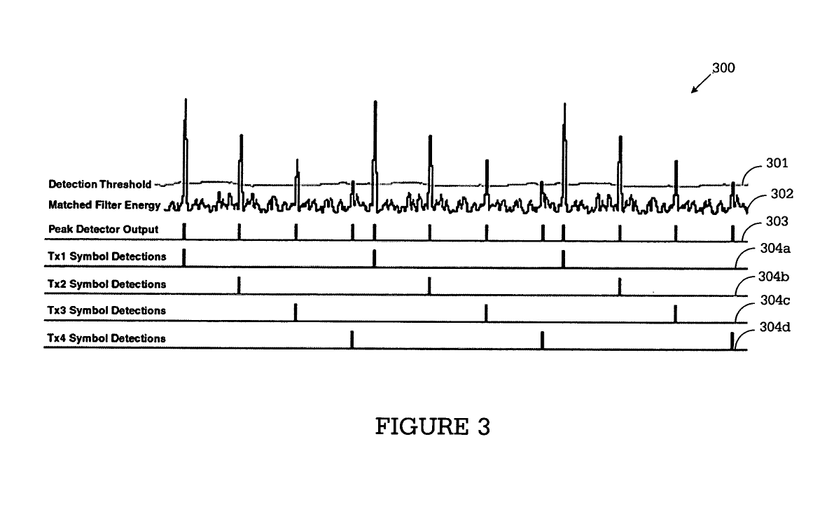

Referring now to FIG. 3, FIG. 3 illustrates a relationship 300 between exemplary signals received in receiver 102 according to one embodiment of the present disclosure. Relationship 300 illustrates a plot of the detection threshold 301 and the matched filter energy 302. FIG. 3 also illustrates the relationship between the peak detector output 303 and the individual symbol detections for each of transmitters 101. Peak detector output 303 includes symbol detections from each transmitter 101a (Tx1), 101b (Tx2), 101c (Tx3) and 101d (Tx4).

In particular, FIG. 3 illustrates the symbol detection plot 304a for transmitter 101a, the symbol detection plot 304b for transmitter 101b, the symbol detection plot 304c for transmitter 101c and the symbol detection plot 304d for transmitter 101d according to one embodiment of the present disclosure. Accordingly, FIG. 3 demonstrates that each periodic sequence of symbols represents the signal from a distinct transmitter 101 and that the receiver 102 can rank the transmitters 101 by the received signal level and thus can decode the messages from transmitters 101 with highest received signal level. For example, the received signal from transmitter 101a may have an unique time of arrival when compared to the same from transmitter 101b.

It should be understood that in one embodiment, the present disclosure provides receivers that are capable of decoding multiple messages received simultaneously. In addition, it should also be understood that the transmitters may be instructed to transmit each message with a pseudo-random delay ranging from zero to one symbol period.

In one embodiment, the present disclosure may be used in various applications for handling message collisions including, for example, applications in which bandwidth may be dynamically allocated according to the traffic requirements. In addition, application in accordance with the present disclosure may enable dynamic traffic estimation which can be used to control network traffic.

Accordingly, the present disclosure provides a system and method of handling message collisions in a data communication system. The present disclosure is not limited to wireless networks, but may be used in any suitable shared medium. In addition, the present disclosure may be used in conjunction with other wireless devices (e.g., mobile stations, conventional cell phones, PCS handsets, personal digital assistant (PDA) handsets, portable computers, telemetry devices, mobile stations, cell phones, wireless laptops, personal data assistants, wireless digital signal processors, etc.), including fixed wireless terminals (e.g., a machine monitor with wireless capability).

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. For use in a data communication network, a method of handling collisions in a receiver, the method comprising:
receiving an input signal having a pseudo-random delay;
detecting a plurality of qualified symbols from the input signal; and
sorting the qualified symbols by their respective signal strengths and times of arrival.

2. The method of claim 1 further comprising:
decoding the sorted symbols by an associated one of separate decoders.

3. The method of claim 1, wherein the sorting further comprises grouping the symbols into separate sequences based on the times of arrival.

4. The method of claim 3, wherein the group of separate sequences are from a distinct one of a plurality of transmitters.

5. The method of claim 1 further comprising:
retaining the sequences with sufficient signal strength quality;
ranking the retained sequences by the received signal strength; and
decoding the input signals with the highest received signal strength.

6. The method of claim 1, wherein the retaining occurs when at least 75% of the symbols in a respective one of sequences are detected with sufficient quality.

7. The method of claim 1, wherein the pseudo-random delay ranges from zero to one symbol period.

8. The method of claim 1, wherein the method is suitable for use in a wireless communication system.

9. For use in a data communication network, a collision handling receiver, the receiver comprising:
a filter to detect symbols from an input signal; and
a decoder to group the symbols into separate sequences based on their respective times of arrival and to decode the sorted symbols.

10. The receiver of claim 9, wherein the decoder retains the sequences with sufficient signal strength quality

11. The receiver of claim 9, wherein the decoder retains a respective one of the sequences when occurs when at least 75% of the symbols in the respective one of sequences are detected with sufficient quality.

12. The receiver of claim 9, wherein the decoder ranks the retained sequences by the received signal strength.

13. The receiver of claim 11, wherein the decoder decodes the retained sequences with the highest received signal strength.

14. The receiver of claim 9, wherein the receiver is part of a wireless communication system.

15. For use in a data communication network, a method of handling collisions in a receiver, the method comprising:
receiving an input signal composed of one or more symbol sequences, each sequence having independent pseudo-random delay;
detecting a plurality of qualified symbols from the input signal;
sorting the qualified symbols by their respective times of arrival;
grouping the sorted symbols into separate sequences based on the times of arrival;
retaining the sequences with sufficient signal strength quality;
ranking the retained sequences by the received signal strength; and
decoding the input signals with the highest received signal strength.

16. The method of claim 15, wherein the decoding further comprises decoding the sorted symbols by an associated one of a plurality of separate decoders.

17. The method of claim 15, wherein each one of the separate sequences are from a distinct one of a plurality of transmitters.

18. The method of claim 15, wherein the pseudo-random delay ranges from zero to one symbol period.

19. The method of claim 15, wherein the decoder retains a respective one of the sequences when at least 75% of the symbols in the respective one of sequences are detected with sufficient quality.

20. The method of claim 15, wherein the data communication network is a wireless network.
